(19) United States
(12) Patent Application Publication
(10) Pub. No.: US 2002/0029634 A1
(43) Pub. Date: Mar. 14, 2002

(54) Container content level gauge apparatus

(75) Inventor: James Jahn, Yoakum, TX (US)

Correspondence Address: Cline H. White, JACKSON WALKER, LLP, Suite 2100, 112 E. Pecan, San Antonio, TX, 78205, US

(73) Assignee: Merchants Moving & Storage, Inc.

(21) Appl. No.: 09/862,354

(22) Filed: May 22, 2001

Related U.S. Application Data
(60) Provisional application No. 60/208,350, filed on May 31, 2000.

(51) Int. Cl. G01F 23/02

(52) U.S. Cl. 73/323; 73/290 B

(57) ABSTRACT

The present invention provides an apparatus for indicating the level of contents within a drum. Specifically, a user can estimate the content level of a drum from a distance. The present invention is particularly useful for hunters who can determine the level of feed remaining in an automatic deer feeder from a distance. The level is discernable by virtue of a brightly colored level indicator rod, and the contents of the drum are protected from having moisture and other debris enter into the drum through the present inventions access hole by virtue of a clear or transparent cover tube.

### BACKGROUND OF THE INVENTION

Field of The Invention

The present invention relates to a device used for measuring the level of the contents within a container. Specifically, the invention relates to a level indicator for quickly indicating the approximate amount of feed left in an automatic animal feeder.

Hunters often use automatic deer feeders to entice deer to a feeding location. In order to effectively use such an apparatus, deer feeders have been made automatic such that corn or other deer feed is stored in a storage container and a specified amount is dropped or scattered at timed intervals. Such feeders come in a variety of designs and styles and may often be homemade or made in small machine shops. Hunters place the feeders at desirable locations, fill the feeder with a suitable deer feed, and set a timer for scattering deer feed. The timer will continue to run and scatter feed at pre-set times. If there is feed in the container, the mechanism works to scatter it, however if the container is empty then the timer continues to work but no feed is scattered. Often deer feeders are placed in relatively remote areas where it is hard for the hunter to reach, or the hunter wishes to have as little contact with the feeder as possible and thereby not disturb deer who may be coming to the feeder. Therefore, it is desirable to have a measuring indicator that would be easily seen from a distance by the hunter in order to indicate whether or not the feed container needs to be refilled. Additionally, it is desirable for such an apparatus to be easily fit to an existing feeder without undo work.

### SUMMARY OF THE INVENTION

The present invention includes a level indicator that sits atop the feed within the container. An indicator rod extends upwardly through the container top and is visible from the outside. As the feed is dispensed, the feed level lowers and the contact plate lowers along with the feed level. As the level indicator rod lowers into the container less is seen from the outside and when the contact plate reaches a predetermined level it is apparent from the outside by viewing the indicator rod. The user may choose to have the indicator rod in contrasting colors so that when the content level is at an acceptable level one color is shown above the top of the container while when the contents go below a specified level then only a second color shows.

The present invention also incorporates a cover tube through which the level indicator rod slides. The tube would provide extra support for the level indicator rod as well as keeping moisture and other debris from entering the feed container. Generally, the cover tube would be made of a clear or transparent material through which the level indicator rod could be seen. A tube plug in the top of the cover tube would keep moisture and other debris from entering the cover tube.

In order to install the present invention, the user needs simply to drill a hole in the top of the feed container of a size large enough to allow the level indicator to easily slide through said hole but of a size small enough so that the base completely covers the hole. Preferably, the hole would be slightly larger than the diameter of the indicator rod. The base is then attached to the top of the feed container such that the hole in the base and optional rod support are directly over the hole in the top of the storage container. The contact plate and level indicator rod are then placed inside the container and the upper portion of the level indicator rod run through the base and rod support holes.

Whenever feed is added to the container, the contact plate is placed on top of the feed. The level indicator rod is never attached directly to the base, rod support, or cover tube but is inserted slidably through the access hole of the base and rod support.

### BRIEF DESCRIPTION OF THE DRAWINGS

The invention will be better understood in objects other than those set forth above and will become apparent when consideration is given to the following detailed description of preferred embodiments. Such description makes reference to the annex drawings wherein:

FIG. 1 shows a perspective view of the present invention.

FIG. 2 shows a full sectional view of the present invention mounted upon a storage container.

FIG. 3 shows a partial sectional view of the present invention mounted upon a storage container.

### DETAILED DESCRIPTION OF THE PREFERRED EMBODIMENT

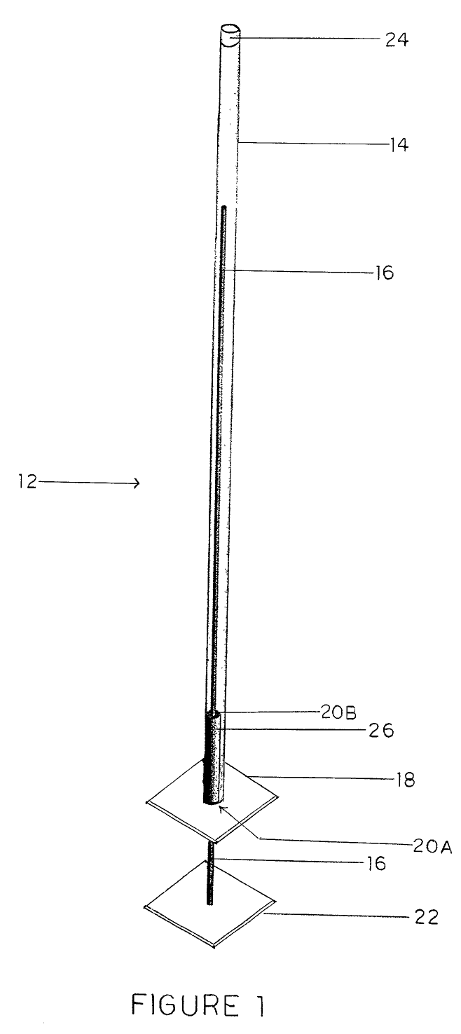

Turning to the figures, in FIG. 1 it may be seen that the container content level gauge (12) incorporates a base (18) having a generally, centrally located access hole (20a).

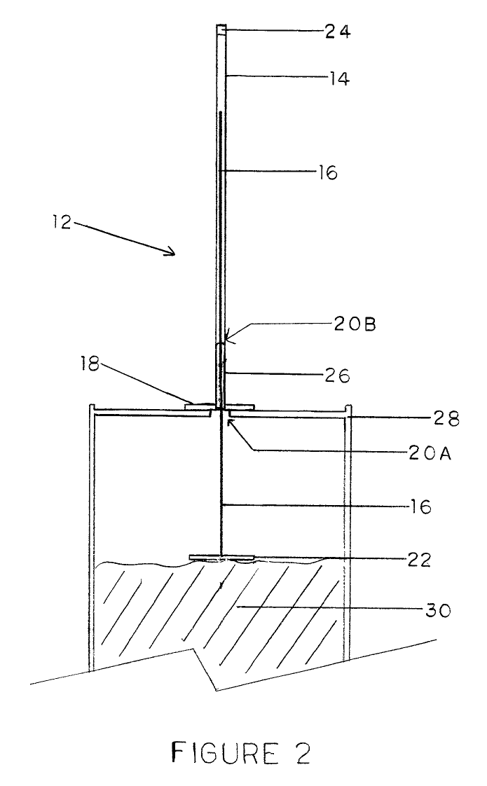

A rod support (26) maybe attached to the base (18) over the access hole (20a). If a rod support (26) is attached, the rod support (26) has an access hole (20b) along its transverse axis that corresponds with the access hole (20a) of the base (18). Slidably inserted through the access holes (20a & 20b) is a level indicator rod (16). The level indicator rod (16) is attached at its bottom to a contact plate (22). The container content level gauge (12) may also be fitted with a cover tube (14) in order to protect the level indicator rod (16) from the elements, and prevent moisture and other debris from entering the container (28 in FIG. 2) through the access holes (20a & 20b). The cover tube (14) is preferably made from a clear or transparent material through which the level indicator rod (16) may be seen. Additionally, the cover tube (14) may be manufactured such that the top is closed, or it may incorporate a tube plug (24) to seal out moisture and debris.

FIG. 2 illustrates the orientation in which the container content level gauge (12) is attached to a container (28), as shown in a sectional view. The base (18) is attached to the container (28) and the level indicator rod (16) is inserted through the access hole (20a). Outside the container (28), is the base (18), the rod support (26), the cover tube (14) and the tube plug (24). Extending within the tube cover (14) outside the container (28) through the access holes (20a & 20b), into the container (28) and attached to the contact plate (22), is the level indicator rod (16). The contact plate (22) rests upon the contents (30) held within the container (28). The level indicator rod (16) and the rod support (26) are visible through the cover tube (14). In a preferred embodiment of the container content level gauge (12), the level indicator rod's (16) outer surface is a bright, easily visible color or pigment such that it has a daytime conspicuity that may be seen by a user of normal vision from at least 150 feet. The tube plug (24) acts to keep moisture and debris from entering the cover tube (14). As shown in this figure, the feeder (28) is relatively full of feed (30), however as the level of the feed (30) drops the contact plate (22) would likewise move down and the level indicator rod (16) would move lower within the cover tube (14) when it gets to a point, as determined by the user, that indicates the feed (30) level is too low, the user would know to add more feed (30) to the container (28). Once more feed (30) is added, the contact plate (22) should be reset on the top of the feed (30) within the container (28).

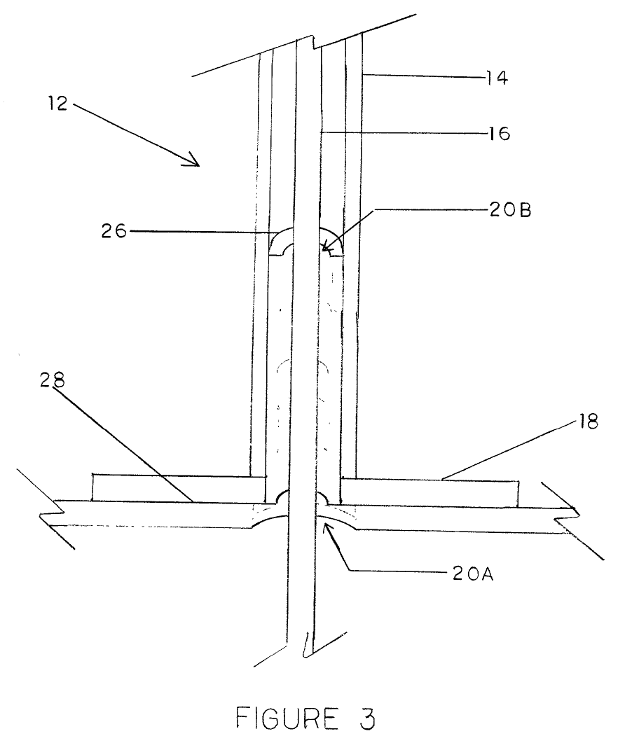

FIG. 3 is a partial sectional view of the container content level gauge (12) attached to a container (28), more clearly showing the base (18) is attached to the container (28). It further illustrates the level indicator rod (16) is extending through the access holes (20a & 20b). Outside the container (28), is the base (18), the rod support (26), and the cover tube (14). The tube cover (14) is attached to the base (18) and extends generally perpendicularly to both the base (18) and the container (28). The tube cover (14) may be made from a rigid clear material, such as glass, plastic, or plexiglass, such that the level indicator rod (16) may be viewed from the outside.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that the appending claims will cover such modifications that follow through the true scope of the invention.

I claim:

1. A container content level gauge apparatus comprising:
a base member attachable on a first side to said container, said base member having a generally centrally located access hole;
a contact plate;
a level indicator rod attached at a first end to a first surface of said contact plate, said indicator rod extending generally perpendicularly from said first surface; and
said level indicator rod slidably insertable through said access hole of said base member.

2. The apparatus of claim 1 further comprising:
a rod support attached at a first end to a second side of said base member, said rod support being generally cylindrical in shape and having a hole extending longitudinally through the center axis of said rod support, said hole sized such that said level indicator rod is slidably inserted through said hole of said rod support.

3. The apparatus of claim 1 further comprising:
a cover tube attached to said base, said cover tube having a hole extending along the longitudinal axis of said cover tube, said hole sized such that said rod support is slidably insertable through said hole;
the length of said cover tube sized such that said level indicator rod fits within said cover tube; and
said cover tube having a clear portion through which said level indicator rod may be viewed.

4. The apparatus of claim 1 further comprising:
said level indicator rod having a pigment at its surface such that it has a daytime conspicuity of at least 150 feet.

5. A container content level gauge apparatus comprising:
a base member attachable on a first side to said container, said base member having a generally centrally located access hole;
a contact plate;
a level indicator rod attached at a first end to a first surface of said contact plate, said indicator rod extending generally perpendicularly from said first surface;
said level indicator rod slidably insertable through said access hole of said base member;
a rod support attached at a first end to a second side of said base member, said rod support being generally cylindrical in shape and having a hole extending longitudinally through the center axis of said rod support, said hole sized such that said level indicator rod is slidably inserted through said hole of said rod support;
a cover tube attached to said base, said cover tube having a hole extending along the longitudinal axis of said cover tube, said hole sized such that said rod support is slidably insertable through said hole;
the length of said cover tube sized such that said level indicator rod fits within said cover tube;
said cover tube having a clear portion through which said level indicator rod may be viewed;
said level indicator rod having a color at its surface such that it has a daytime conspicuity of at least 150 feet.
